(19) United States
(12) Patent Application Publication
(10) Pub. No.: US 2013/0332243 A1
(43) Pub. Date: Dec. 12, 2013

(54) PREDICTIVE ANALYTICS BASED RANKING OF PROJECTS

(71) Applicants: Wesley M. Gifford, New Canaan, CT (US); Nitinchandra R. Nayak, Ossining, NY (US)

(72) Inventors: Wesley M. Gifford, New Canaan, CT (US); Nitinchandra R. Nayak, Ossining, NY (US)

(73) Assignee: International Business Machines Corporation, Armonk, NY (US)

(21) Appl. No.: 13/494,107

(22) Filed: Jun. 12, 2012

(51) Int. Cl. G06Q 10/06

(52) U.S. Cl. 705/7.37

(57) ABSTRACT

The exemplary embodiments of the invention provide at least a method and machine including a memory tangibly embodying at least one program of instructions executable by at least one processor to perform operations with the machine including inputting project data of at least one project, applying more than one layer of different predictive models to the input project data, where the different predictive models are applied in a hierarchical manner across the more than one layer taking into account at least one of data availability and a stage of a lifecycle of each of the at least one project, and based on the applied more than one predictive model, determining a predicted future performance for each project of the at least one project

### TECHNICAL FIELD

The exemplary embodiments of the invention relate generally to assisting project management by identifying projects in a portfolio that are likely to encounter problems. More specifically, the exemplary embodiments of the invention provide at least a method to assist project management by identifying projects in a portfolio that have a higher likelihood of encountering problems in the future thereby supporting early management intervention.

### BACKGROUND OF THE INVENTION

The known solutions primarily analyze the current condition of a project to assess whether it requires management intervention. In such approaches, a project has to start showing signs of problems before management intervention is applied. Since these approaches are not able to predict whether a project doing well today will encounter serious problems in the future, they do not support management intervention early enough to prevent such future problems. Also, these solutions assume that the same information is available for each project in the portfolio regardless of its age. However, in most cases, projects that have just recently started do not have any or enough performance history as compared to older projects for which data history spans several time periods.

### BRIEF SUMMARY OF THE INVENTION

The foregoing and other problems are overcome, and other advantages are realized, in accordance with the presently preferred embodiments of these teachings.

In an exemplary aspect of the invention, there is a method comprising inputting project data of at least one project; applying more than one layer of different predictive models to the input project data, where the different predictive models are applied in a hierarchical manner across the more than one layer taking into account at least one of data availability and a stage of a lifecycle of each of the at least one project; and based on the applied more than one predictive model, determining a predicted future performance for each project of the at least one project.

In an another exemplary aspect of the invention there is a memory readable by a machine, tangibly embodying at least one program of instructions executable by at least one processor to perform operations, said operations comprising: inputting project data of at least one project; applying more than one layer of different predictive models to the input project data, where the different predictive models are applied in a hierarchical manner across the more than one layer taking into account at least one of data availability and a stage of a lifecycle of each of the at least one project; and based on the applied more than one predictive model, determining a predicted future performance for each project of the at least one project.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 shows a block diagram of an exemplary computing system that is one suitable environment in which exemplary embodiments of the invention may be embodied;

FIG. 2 shows an overall flow of solution steps in accordance with the embodiments;

FIG. 3 shows an exemplary overall solution architecture in accordance with the exemplary embodiments; and

FIG. 4 is a block diagram illustrating a method in accordance with an exemplary embodiment of the invention.

### DETAILED DESCRIPTION OF EXEMPLARY EMBODIMENTS

The present invention provides at least a method to assist project management by identifying projects in a portfolio that have a higher likelihood of encountering problems in the future thereby supporting early management intervention.

In accordance with the exemplary embodiments of the invention, a project is analyzed to predict if a project, even a seemingly well-performing, will encounter serious problems in the near future and so will benefit from early management intervention. Each project in the portfolio is scored based on the likelihood of failing to different degrees, the impact of such failure, and the ability to manage the project performance in order to compute its prioritization rank within the portfolio of projects for allocating management resources. Also, the exemplary embodiments of the invention consider that new projects may have limited information with which to discern their performance as compared to older projects.

The exemplary embodiments of the invention can even be used to the benefit of projects in a portfolio which have varying maturities and, as such, different amounts and types of associated information. For example, new projects will have very limited information to describe their performance compared to older projects. As will be described below in more detail, in accordance with an exemplary embodiment of the invention, each project in the portfolio is scored using a common metric regardless of its maturity. A final score indicates a likelihood of a project failing to different degrees, the impact of such failure, and the ability to manage the project's future performance in order to compute its prioritization rank within the portfolio of projects and subsequently for allocating management resources.

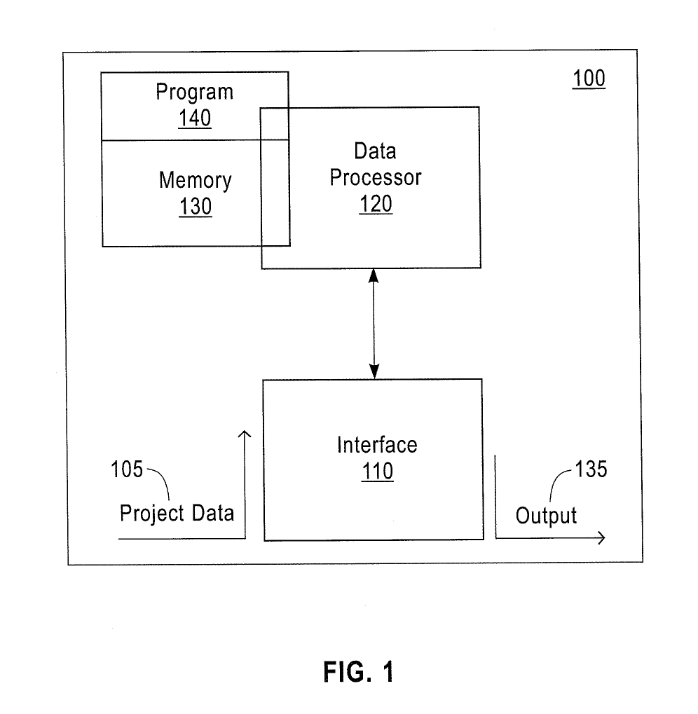

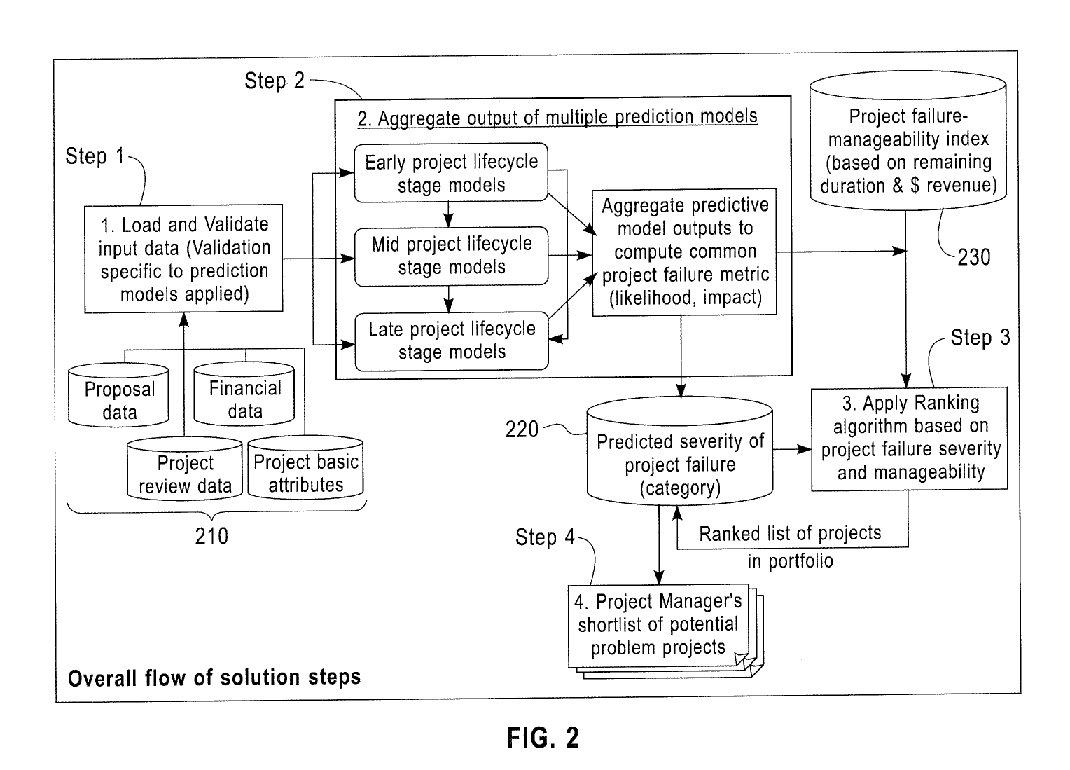

Reference is now made to FIG. 1 for showing a block diagram of an exemplary project ranking system 100 that is one suitable environment in which exemplary embodiments of the invention may be embodied. The system 100 includes at least one data processor (DP) 120 that is coupled with at least one memory (MEM) 130. The memory 130 stores a program (PROG) 140 containing program instructions that, when executed by the data processor 120, results in at least the implementation of the exemplary methods discussed below, including those shown in FIGS. 2, 3, and 4. The data processor 120, memory 130 and program 140 may be considered collectively to form the project ranking system 100. The data processor 120 is coupled to an interface 110 providing bi-directional communication via the interface 110 with any device and/or entity such as a data communication network and/or another communication system. Further, the interface 110 can be used to input and/or output data from any type of user input and/or machine device interface. Project data 105, such as data provided for each project of at least one project, is input to the data processor 120 and operated on by the program 140 executed by the DP 120 to produce output information 135. The output 135 can include a short list of projects that the system 100 has determined to have potential problems which should be addressed. The information output 135 is output through the interface 110. In a non-limiting exemplary embodiment, the project data 105 can be received and/or obtained from a database. Further, the system 100 can proactively access project data from multiple sources simultaneously, such as from a database or a memory of other devices. The system 100 being configured to perform predictive analytics to rank projects as described herein.

The exemplary project ranking system 100 can be embodied in any suitable form, including a main frame computer, a workstation, a portable computer such as a laptop, or any stand alone or network connected device. The data processor 120 can be implemented using any suitable type of processor including, but not limited to, microprocessor(s) and embedded controllers. The memory 130 can be implemented using any suitable memory technology, including one or more of fixed or removable semiconductor memory, fixed or removable magnetic or optical disk memory and fixed or removable magnetic or optical tape memory, as non-limiting examples. The interface 110 can be implemented with any suitable type of wired or wireless network technology, and may interface with a local area network (LAN) or a wide area network (WAN), including the internet. Communication through the network can be accomplished at least in part using electrical signals, radio frequency signals and/or optical signals, as non-limiting examples.

In accordance with the exemplary embodiments the system 100 is configured to perform the method in accordance with the exemplary embodiments as follows:

Assumptions:
It is assumed that the project is completed over a period of time and the associated revenue is gradually redeemed over this period in accordance with the contract terms.
It is assumed that each project has associated with it a target gross profit (percentage) value that depends on several factors and does not change over the delivery period of the project.

Prioritization Criterion:

To develop a prioritized list of projects in a portfolio, the first step performed by the program 140 executed by the DP 120 is to establish the prioritization criteria. The criteria are based on three metrics for any project. These metrics include:
A financial metric that represents the deviation from the target gross profit expected from a given project. This is termed as the gross profit variance (or GP variance) and measured as a percentage value;
a financial metric that represents the loss potential for any project and is measured as the remainder of the project value yet to be redeemed over the remaining duration of the project; and
a manageability factor that represents the management's effort to recover any negative gross profit over the remaining duration of the project. This factor is represented as a number between 0 and 1. A manageability factor of 0 represents that management intervention will have no useful impact and so no further effort should be expended while a value of 1 represents that management should invest all effort in recovering inception to date losses over the remaining duration of the project.

The exemplary embodiments of the invention provide a hierarchically layered solution to transform the available data for each project in the portfolio into the final prioritized list of projects ranked by descending prioritization scores. This data can include:
Data related to the proposal which later became the project. This proposal data includes elements such as perceived complexity of the project, assumptions about skills required and their availability, past experience with delivering similar projects, etc.;
Financial performance of the project over various time intervals (monthly, quarterly, year to date, and inception to date) expressed using various metrics such as revenue, costs, gross profit, gross profit variance, etc.;
Project health-related data such as schedule slippage, skill availability, client feedback, risk mitigation, etc.; and/or
Project details such as attributes of project owner, overall project revenue, expected project costs, target gross profit, expected project duration, etc.

In accordance with the exemplary embodiments there is provided two Solution Approaches as follows:

A Solution Approach I:

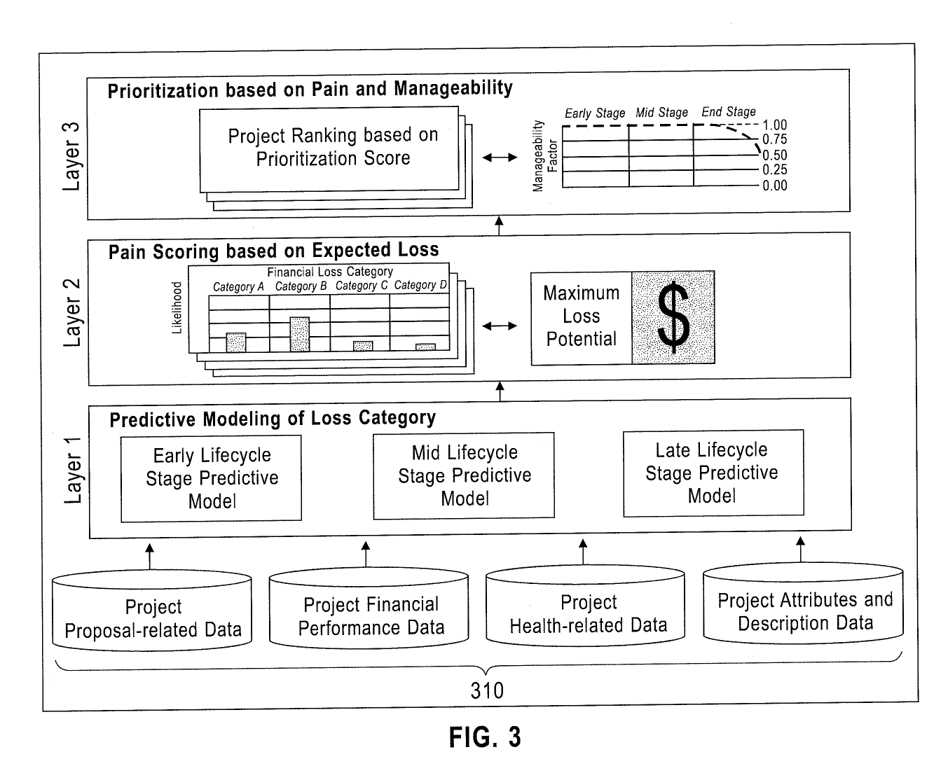

FIG. 2 outlines the overall flow of solution steps while FIG. 3 provides an overview of the hierarchical solution architecture. Although some individual elements of the solution approach are well-known, a novelty of the invention lies in creating a hierarchical flow of information across the solution layers to address the problem posed by uneven data availability for projects of differing maturity. This accomplished through a layer comprising of multiple algorithms, including algorithms tuned to the project's stage in its lifecycle (early, mid, or end stage), for predicting a project's performance metric and aggregating the multiple predictions to compute the common project failure related metric. The other novel aspect includes the use of project's failure-manageability index 230 as one of the factors in computing a project's prioritization score. The project failure-manageability index 230 is based on at least a remaining duration of a project life and on current revenues from the project.

FIG. 2 illustrates some of the details of a solution approach involved in implementing the predictive analytics for project rankings. As illustrated in FIG. 2 there is:

Input project data 210 provided in step 1, such as via interface 110. The project data 210 can include project proposal data, project review data, financial data associated with a project, and/or project basic attributes to name only a few types of input project data. As illustrated in FIG. 2, the steps involved in the exemplary solution approach include:

Step 1: This step is associated with creating and validating the input data provided for each project. Depending on the amount of information available for each project based on its stage in its lifecycle, various models are populated and validated for completeness of information. This step is implemented in Stage 1 of the hierarchical stages as shown in FIG. 3 which will be described in detail below.

Step 2: This step, also implemented in Stage 1 in FIG. 3, contains several predictive models that are designed to predict the project's failure-related metric (e.g., gross profit variance from the target over a predefined period, such as the next 3 months, for each project) including those tuned to the project's stage in its lifecycle—early, mid, or end stage. Since each stage has a different kind and amount of information available for each project, the predictive models are fine-tuned for each individual project according to the available data. The predicted variables for the individual models may differ but these predictions are aggregated to compute a common predicted variable that is fed into Step 3 and implemented in Stage 2 of the solution architecture shown in FIG. 3. Such a common predicted variable could categorically represent the severity of a project's failure along with its likelihood of failure or success. An example of the common predicted variable categories for any project is as below:
category A (defined as gross profit variance from the target is above 0%) with probability 0.2
category B (defined as gross profit variance from the target is between −5% to 0%) with probability 0.6
category C (defined as gross profit variance from the target is between −10% to −5%) with probability 0.1
category D (defined as gross profit variance from the target is below −10%) with probability 0.1

Step 3: This step, implemented in Stages 2 and 3 of the solution architecture of FIG. 3, transforms the common predicted variable into a financial variable (e.g. expected gross profit variance in financial terms based on the loss potential for each project), which allows comparison among various projects. Additionally, this variable for each project is further associated with a project failure severity and manageability index that represents how easy or difficult it is to recover from any potential losses. The algorithm for computing this index takes into account the remaining duration of the project as well as the amount of remaining revenue over this duration. The choice of algorithm is left to the user but one example is creating manageability index profiles for projects with various characteristics such as project type, project complexity, etc. Such profiles can be used to weight the various predicted severity of project failure and/or category of severity 220 of financial losses as part of computing the project's rank in the portfolio. Higher the value of this weighted potential loss, higher is its rank in the portfolio.

Step 4: In step 4 a report is generated to represent a shortlist of projects with potential problems that the project managers should address immediately. The severity of these potential problems can be related to the order in the short list. To reduce the churn in these reports from one period to another, dampening factors may be introduced to gradually move the projects up and down and in and out of the shortlist. Many of these projects may not currently manifest any financial problems but the project attributes should point to issues that if not resolved will lead to financial problems further down the road. Having an early warning about impending problems should support early management intervention.

Solution Approach II:

In accordance with the exemplary embodiments of the invention as illustrated in FIG. 3, there can be included predicted analytics for ranking projects over hierarchical stages or layers. This approach at least addresses problems posed by uneven data availability for projects with different life cycles and/or differing maturities. Input project data 310 is provided to the first stage and then is processed in a hierarchical flow between stages. The project data 310 can include, but is not limited to, project proposal-related data, project financial performance data, project health-related data, project attributes and description data. As illustrated in FIG. 3, the layers involved in the exemplary solution approach include:

Layer 1: This layer contains several predictive models that are designed to predict the gross profit variance from the target for each project based on the stage of its lifecycle—early, mid, or end stage. Since each stage has different kind and amount of information available for each project, the models are fine-tuned to available data. The predicted variable (defined as gross profit variance from target over the next 3 months in percentage terms) is the same for each predictive model and represents a range value along with its likelihood. For example:
category A (defined as gross profit variance from the target is above 0%) with probability 0.2
category B (defined as gross profit variance from the target is between −5% to 0%) with probability 0.6
category C (defined as gross profit variance from the target is between −10% to −5%) with probability 0.1
category D (defined as gross profit variance from the target is below −10%) with probability 0.1

Layer 2: This layer computes the expected gross profit variance in financial terms by including the loss potential for each project

Layer 3: This layer computes the prioritization score for each project taking into account its expected gross profit variance in financial terms and applying the appropriate manageability factor based on the remaining project duration as well as the amount of negative gross profit to be recovered over the remaining revenue base of the project.

Output: In both solution approaches, the output of Layer 3 and/or Step 4 is a prioritized list of projects ranked in descending order of their prioritization score along with some project attributes to help understand the reason for its rank. The project team can now choose to allocate their attention to those projects that are high on the list. Many of these projects may not currently manifest any financial problems but the project attributes should point to issues that if not resolved will lead to financial problems further down the road. Having an early warning about impending problems should support early management intervention.

This hierarchical solution architecture, in accordance with the exemplary embodiments, is developed to transform the available data for each project in the portfolio into the final prioritized list of projects ranked by descending prioritization scores.

Context Sensitive Predictive Model Aggregation:

One of the key components of the invention is the mechanism by which the different predictive models are combined at various stages of the project lifecycle. In particular, many organizations leveraging predictive analytics have developed a variety of algorithms and analytical tools that attempt to predict a similar outcome (e.g., project failure) from sets of disjoint data. It is infeasible to rebuild all these models to tailor the output for our purposes, yet we still want to leverage all available information. Furthermore, these models may utilize many different underlying algorithms and we do not want our results to be dependent on the particular algorithm used.

Consider the case where at each project lifecycle stage i, we have nᵢ predictive models available plus any models from previous stages which may or may not be relevant. We denote the kth prediction model at the ith stage as

f_{i,k}(S_{i,k})=ĥ_{i,k}

Here, S_{i,k} denotes the set of information required by the prediction model and ĥ_{i,k} denotes the predicted output. There are no restrictions on what S_{i,k} includes, for example it may consist of financial information, answers to specific questions designed to target a particular aspect of the project, or any other available data. In general there are also no restrictions on what is output by the predictor, the only requirement is that the output of the individual models at all stages in a project's lifecycle are similar. In our case, each predictor is designed to predict the future state of the project's health. One way to do that, as described above, is to view ĥ_{i,k} as a vector of four elements each indicating the probability of entering a particular health state (A, B, C, or D) indicating different levels of severity of project failure.

An aggregate model at stage i can then be formulated as

gᵢ(Tᵢ)=\hat{ĥ}ᵢ

where

$${T}_{i} = {U}_{j \leq i , k \leq {n}_{j}} {\hat{h}}_{j , k}$$

where is the union of all available outputs of predictors up to and including stage i. The predicted output, \hat{ĥ}ᵢ, represents the aggregated prediction which leverages all the available information at stage i. The function gᵢ(•) is determined during the model training process based on the predicted outputs of the available models and the future state of the contract from a historical dataset of contracts. During the model building process, many prior models (particularly the older ones) may not be as indicative of the future contract state. These will be identified and removed from the set Tᵢ, yielding a potentially smaller set Tᵢ′⊂Tᵢ. Since there are now several aggregate models (one for each of the stages), each aggregate model can become sensitive to the particular set of prior models that are most important for that particular stage.

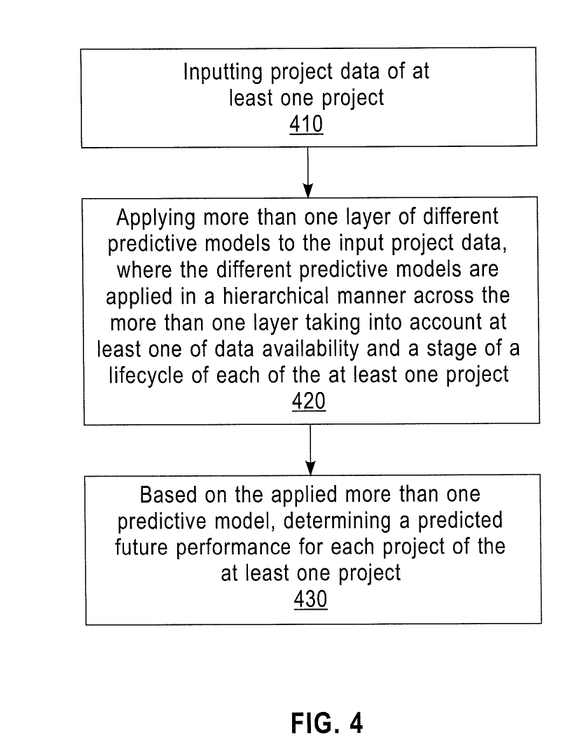

FIG. 4 is a block diagram illustrating a method in accordance with the exemplary embodiments of the invention. In block 410 there is inputting project data of at least one project. Then in block 420 there is applying more than one layer of different predictive models to the input project data, where the different predictive models are applied in a hierarchical manner across the more than one layer taking into account at least one of data availability and a stage of a lifecycle of each of the at least one project. In block 420 there is, based on the applied more than one predictive model, determining a predicted future performance for each project of the at least one project.

The exemplary embodiments of the invention as described in the paragraph above, where the project data comprises financial performance information and data related to financial health of the project during the various time intervals of the project.

In accordance with the exemplary embodiments as described in the paragraphs above, where the different predictive models applied in the hierarchical manner are fine-tuned for each individual project based on the available data for each project.

In accordance with the exemplary embodiments as described in the paragraphs above, where determining the predicted future performance comprises first validating project data for each project of the at least one project.

In accordance with the exemplary embodiments as described in the paragraph above, where the determining the predicted future performance is performed in more than one stage and where at least one different predictive model is used in each stage of the more than one stage.

In accordance with the exemplary embodiments as described in the paragraph above, where a first stage of the more than one stage comprises populating the more than one predictive model based on an amount of the validated data and on a stage of a lifecycle for a project, and where a second stage computes a common predicted variable associated with a failure related metric of each project of the at least one project.

In accordance with the exemplary embodiments as described in the paragraph above, where the common predicted variable is transformed to a financial variable in a third stage, the financial variable representing one of a loss or profit potential of the at least one project.

In accordance with the exemplary embodiments as described in the paragraphs above, where the transforming takes into account a remaining duration of a project life cycle and an amount of remaining revenue for the project.

In accordance with the exemplary embodiments as described in the paragraphs above, where the determining the predicted future performance at a stage subsequent to the third stage comprises generating a report comprising a short list of the at least one project, where the short list is in an order based at least on the financial variable.

In accordance with the exemplary embodiments as described in the paragraphs above, where a predictive model of the more than one predictive model comprises an algorithm for determining a kth prediction model at an ith stage of

f_{i,k}(S_{i,k})=ĥ_{i,k}

where S_{i,k} denotes the set of information required by the prediction model and ĥ_{i,k} denotes a predicted output.

In accordance with the exemplary embodiments as described in the paragraph above, where the predictive model comprises an aggregate model at stage i formulated as

gᵢ(Tᵢ)=\hat{ĥ}ᵢ,

where

$${T}_{i} = {U}_{j \leq i , k \leq {n}_{j}} {\hat{h}}_{j , k}$$

is a union of all available outputs of predictors up to and including stage i, where ĥ_{i,k} as a vector of four elements each indicating the probability of entering a particular health state, and where function gᵢ(•) is determined during a model training process based on the predicted outputs of the available models and a future state of a contract from a historical data set of contracts associated with a project.

In accordance with the exemplary embodiments as described in the paragraph above, where during the model training process prior models are identified and removed from a set Tᵢ, yielding a potentially smaller set Tᵢ′⊂Tᵢ.

In addition, the method according to the exemplary embodiments of the invention may be performed by an apparatus comprising at least one processor, and at least one computer readable memory embodying at least one computer program code, where the at least one computer readable memory embodying the at least one computer program code is configured, with the at least one processor to perform the method according to at least the paragraphs above.

Further, in accordance with the exemplary embodiments of the invention, there is an apparatus comprising means for collecting metrics from one or more network devices of the wireless communication network, and means for using the collected metrics to enable one of establishment and modification of a Bearer in the wireless communication network to provision a service in accordance with specified characteristics.

Generally, various exemplary embodiments of the invention can be implemented in different mediums, such as software, hardware, logic, special purpose circuits or any combination thereof. As a non-limiting example, some aspects may be implemented in software which may be run on a computing device, while other aspects may be implemented in hardware such as with the system 100.

The foregoing description has provided by way of exemplary and non-limiting examples a full and informative description of the exemplary embodiments of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

1. A method comprising:
inputting project data of more than one project;
applying more than one layer of different predictive models to the input project data, where the different predictive models are applied in a hierarchical manner across the more than one layer taking into account at least one of data availability and a stage of a lifecycle of each of the more than one project, and where the applying comprises:
applying a first layer of the different predictive models to the input project data to predict a gross profit variance for each of the more than one project, where the gross profit variance is defined in percentage terms,
applying a second layer of the different predictive models using at least the predicted gross profit variance to compute a financial metric that represents a loss potential for each of the more than one project, where the financial metric is computed as a remainder of value yet to be redeemed over a remaining project duration of each of the more than one project, and
applying a third layer of the different predictive models to compute a prioritization score for each of the more than one project, where computing the prioritization score is taking into account the predicted gross profit variance and is applying a manageability factor based on the remaining project duration as well as an amount of negative gross profit to be recovered from revenues of each of the more than one project over the remaining project duration; and
based on the applied more than one predictive model, determining a predicted future performance for each project of the more than one project, and outputting a list of the more than one project ranked in descending order of their prioritization score, where the list includes project attributes which provide information related to the rank for each of the more than one projects of the list.

2. The method according to claim 1, where the project data comprises financial performance information and data related to financial health of the project during the various time intervals of the project.

3. The method according to claim 1, where the different predictive models applied in the hierarchical manner are fine-tuned for each individual project of the more than one project based on the available data for each project.

4. The method according to claim 1, where the determining the predicted future performance comprises first validating project data for each project of the more than one project.

5. The method according to claim 4, where at least one different predictive model is used in each stage of the more than one stage.

6. The method according to, where the first stage comprises populating the more than one predictive model based on an amount of the validated data and on a lifecycle for a project, and where the second stage computes a common predicted variable associated with the loss potential for each project of the more than one project.

7. The method according to claim 6, where the common predicted variable is transformed to a financial variable in the third stage, the financial variable representing one of a loss or profit potential of the at least one project.

8. The method according to claim 7, where the transforming takes into account a remaining duration of a project life cycle and an amount of remaining gross profit target for each project of the more than one project.

9. The method according to claim 7, where the determining the predicted future performance at a stage subsequent to the third stage comprises generating a report comprising a list of the at least one project, where the list is in an order based at least on the financial variable.

10. The method according to claim 1, where a predictive model of the more than one predictive model comprises an algorithm for determining a kth prediction model at an ith stage of
f_{i,k}(S_{i,k})=ĥ_{i,k},
where S_{i,k} denotes the set of information required by the prediction model and ĥ_{i,k} denotes a predicted output.

11. The method according to claim 10, where the predictive model comprises an aggregate model at stage i formulated as
gᵢ(Tᵢ)=\hat{ĥ}ᵢ,
where
$${T}_{i} = {U}_{j \leq i , k \leq {n}_{j}} {\hat{h}}_{j , k}$$
is a union of all available outputs of predictors up to and including stage i, where ĥ_{i,k} as a vector of four elements each indicating the probability of entering a particular health state, where function gᵢ(•) is determined during a model training process based on the predicted outputs of the available models and a future state of a contract from a historical data set of contracts associated with a project.

12. The method according to claim 11, where during the model training process prior models are identified and removed from a set Tᵢ, yielding a potentially smaller set Tᵢ′⊂Tᵢ.

13-24. (canceled)

25. The method according to claim 1, where the gross profit variance of the more than one project is predicted for a three month period, and where the predicted gross profit variance defined in the percentage terms is based on a gross profit target expected for each of the more than one project.
